(19) United States
(12) Patent Application Publication
(10) Pub. No.: US 2019/0213968 A1
(43) Pub. Date: Jul. 11, 2019

(54) ARRAY SUBSTRATE, METHOD FOR DRIVING THE SAME, AND DISPLAY APPARATUS

(71) Applicants: BEIJING BOE DISPLAY TECHNOLOGY CO., LTD., Beijing (CN); BOE TECHNOLOGY GROUP CO., LTD., Beijing (CN)

(72) Inventors: Guohuo SU, Beijing (CN); Zhihua SUN, Beijing (CN); Shulin YAO, Beijing (CN); Guangquan HE, Beijing (CN); Ning ZHANG, Beijing (CN); Jituo TANG, Beijing (US)

(21) Appl. No.: 16/327,773

(22) PCT Filed: Apr. 28, 2018
(86) PCT No.: PCT/CN2018/085166

§ 371 Date: Feb. 22, 2019

(30) Foreign Application Priority Data
Aug. 14, 2017 (CN) 201710691065.9

(51) Int. Cl. G09G 3/36

(52) U.S. Cl. CPC G09G 3/3655; G09G 2320/0257

(57) ABSTRACT

The embodiments of the present disclosure disclose an array substrate, a method for driving the same, and a display apparatus. The array substrate includes: a plurality of data lines; a plurality of scanning lines intersecting the plurality of data lines to form a matrix array; a common electrode line; a plurality of pixel sub-circuits disposed at intersections of the data lines and the scanning lines, wherein each of the pixel sub-circuits comprises a pixel transistor and a pixel capacitor, wherein the pixel capacitor is connected between a corresponding one of the data lines and the common electrode line via the pixel transistor, and a control terminal of the pixel transistor is connected to a corresponding one of the scanning lines; and control sub-circuits, each connected between a respective data line and the common electrode line respectively and configured to zero a voltage difference across a pixel capacitor in each of pixel sub-circuits connected to the respective data line based on a control signal.

### CROSS-REFERENCE TO RELATED APPLICATION(S)

This application claims priority to the Chinese Patent Application No. 201710691065.9, filed on Aug. 14, 2017, which is incorporated herein by reference in its entirety.

### TECHNICAL FIELD

The present disclosure relates to the display field, and more particularly, to an array substrate, a method for driving the same, and a display apparatus.

### BACKGROUND

In a conventional Liquid Crystal Display (LCD), a gate driving circuit for driving a gate may be formed on a Gate drive On Array (GOA). When the display apparatus is powered off, a gate of a Thin Film Transistor (TFT) on the display apparatus is set to be at, for example, a high level by the gate driving circuit disposed on the GOA panel to turn on the thin film transistor, so that a voltage of a pixel capacitor is rapidly reduced to zero, thereby causing the display apparatus to display a black screen.

However, in the conventional LCD display apparatus, it is impossible for the gate driving circuit to reduce a voltage of each pixel capacitor rapidly, and thus a poor phenomenon such as an observable afterimage etc. may occur when the LCD panel is turned off.

### SUMMARY

The embodiments of the present disclosure provide an array substrate, a method for driving the same, and a display apparatus.

According to an aspect of the embodiments of the present disclosure, there is provided an array substrate, comprising:

a plurality of data lines;

a plurality of scanning lines intersecting the plurality of data lines to form a matrix array;

a common electrode line;

a plurality of pixel sub-circuits disposed at intersections of the data lines and the scanning lines, wherein each of the pixel sub-circuits comprises a pixel transistor and a pixel capacitor, wherein the pixel capacitor is connected between a corresponding one of the data lines and the common electrode line via the pixel transistor, and a control terminal of the pixel transistor is connected to a corresponding one of the scanning lines; and

control sub-circuits, each connected between a respective data line and the common electrode line and each configured to zero a voltage difference across a pixel capacitor in each of pixel sub-circuits connected to the respective data line based on a control signal.

In an example, each of the control sub-circuits comprises a control transistor configured to control a column of pixel sub-circuits.

In an example, each of the control sub-circuits comprises two control transistors configured to control the same column of pixel sub-circuits and arranged on opposite ends of the same column of pixel sub-circuits respectively.

In an example, the array substrate further comprises: a first power source line, wherein a control terminal of the control transistor is connected to the first power source line, a first terminal of the control transistor is connected to one of the data lines corresponding to the column of pixel sub-circuits controlled by the control transistor, and a second terminal of the control transistor is connected to the common electrode line.

In an example, a control terminal of the pixel transistor of each of the pixel sub-circuits is connected to one of the scanning lines for a row where the pixel sub-circuit is located, a first terminal of the pixel transistor is connected to one of the data lines for a column where the pixel sub-circuit is located, and a second terminal of the pixel transistor is connected to a first terminal of the pixel capacitor, and a second terminal of the pixel capacitor is connected to the common electrode line.

In an example, in a first period, the control transistor is turned off, and the pixel transistor operates according to a voltage signal on a corresponding one of the scanning lines; and in a second period, the control transistor and the pixel transistor are turned on, so that opposite ends of the pixel capacitor are connected to one of the data lines corresponding to a corresponding column.

In an example, the array substrate further comprises: a second power source line connected to the plurality of scanning lines to provide power to the plurality of scanning lines; and a control signal generation sub-circuit configured to generate the control signal based on a trigger signal, and output the control signal to the first power source line, the second power source line, and the plurality of scanning lines to control voltages applied to the first power source line, the second power source line and the scanning lines respectively.

According to another aspect of the embodiments of the present disclosure, there is provided a display apparatus comprising the array substrate according to the embodiments of the present disclosure.

According to yet another aspect of the embodiments of the present disclosure, there is provided a method for driving the array substrate according to the embodiments of the present disclosure, comprising:

obtaining a control signal; and

zeroing a voltage difference across a pixel capacitor in each of pixel sub-circuits connected to the data lines based on the control signal.

In an example, the step of obtaining a control signal comprises: receiving a trigger signal; and generating the control signal based on the received trigger signal.

In an example, the control sub-circuit comprises at least one control transistor, each of which is configured to control a column of pixel sub-circuits; and a control terminal of the pixel transistor of each of the pixel sub-circuits is connected to one of the scanning lines for a row where the pixel sub-circuit is located, a first terminal of the pixel transistor is connected to one of the data lines for a column where the pixel sub-circuit is located, and a second terminal of the pixel transistor is connected to a first terminal of the pixel capacitor, and a second terminal of the pixel capacitor is connected to the common electrode line;

the method further comprises: turning off the control transistor before the control signal is obtained, wherein the pixel transistor operates according to a voltage signal on a corresponding one of the scanning lines, and

the step of zeroing a voltage difference across a pixel capacitor in each of pixel sub-circuits connected to the data lines comprises: turning on the control transistor and the pixel transistor, so that opposite ends of the pixel capacitor are connected to one of the data lines corresponding to a corresponding column.

In an example, the array substrate further comprises: a first power source line connected to the plurality of data lines to provide power to the plurality of data lines; a second power source line connected to the plurality of scanning lines to provide power to the plurality of scanning lines; and a control signal generation sub-circuit configured to generate the control signal based on the trigger signal. The step of zeroing a voltage difference across a pixel capacitor in each of pixel sub-circuits connected to the data lines comprises: generating, by the control signal generation sub-circuit, the control signal based on the trigger signal, so that a voltage applied to the first power source line is equal to a voltage applied to the second power source line.

### BRIEF DESCRIPTION OF THE ACCOMPANYING DRAWINGS

FIG. 1 illustrates a schematic block diagram of an array substrate according to an embodiment of the present disclosure;

FIG. 2A illustrates a circuit diagram of an array substrate according to an embodiment of the present disclosure;

FIG. 2B illustrates a circuit diagram of an array substrate according to another embodiment of the present disclosure;

FIG. 3 illustrates a schematic block diagram of an array substrate according to yet another embodiment of the present disclosure;

FIG. 4 illustrates an operation timing diagram of driving an array substrate according to an embodiment of the present disclosure;

FIG. 5 illustrates a schematic block diagram of a display apparatus according to an embodiment of the present disclosure; and

FIG. 6 illustrates a schematic flowchart of a method for driving an array substrate according to an embodiment of the present disclosure.

### DETAILED DESCRIPTION

In order to make the purposes, technical solutions and advantages of the embodiments of the present disclosure more clear, the technical solutions in the embodiments of the present disclosure will be clearly and completely described below in conjunction with the accompanying drawings in the embodiments of the present disclosure. Obviously, the embodiments described are a part of the embodiments of the present disclosure instead of all the embodiments. All other embodiments obtained by those of ordinary skill in the art based on the described embodiments of the present disclosure without contributing any creative work are within the protection scope of the present disclosure. It should be illustrated that throughout the accompanying drawings, the same elements are represented by the same or similar reference signs. In the following description, some specific embodiments are for illustrative purposes only and are not to be construed as limiting the present disclosure, but merely examples of the embodiments of the present disclosure. The conventional structure or construction will be omitted when it may cause confusion with the understanding of the present disclosure. It should be illustrated that shapes and dimensions of components in the figures do not reflect true sizes and proportions, but only illustrate contents of the embodiments of the present disclosure.

Unless otherwise defined, technical terms or scientific terms used in the embodiments of the present disclosure should be of ordinary meanings to those skilled in the art. “First”, “second” and similar words used in the embodiments of the present disclosure do not represent any order, quantity or importance, but are merely used to distinguish between different constituent parts.

Furthermore, in the description of the embodiments of the present disclosure, the term “connected” or “connected to” may mean that two components are directly connected, or that two components are connected via one or more other components. In addition, the two components can be connected or coupled by wire or wirelessly.

The transistors used in the embodiments of the present disclosure may each be a thin film transistor or a field effect transistor or other devices having the same characteristics. The thin film transistor used in the embodiments of the present disclosure may be an oxide semiconductor transistor. Since a source and a drain of the thin film transistor used herein are symmetrical, the source and the drain thereof may be interchanged. In the embodiments of the present disclosure, the gate is referred to as a control terminal, one of the source and the drain is referred to as a first terminal, and the other of the source and the drain is referred to as a second terminal, depending on their functions.

In an LCD display apparatus, each pixel may comprise a pixel transistor and a pixel capacitor, wherein display brightness and a display color of the pixel unit are controlled by a voltage of the pixel capacitor, and charging and discharging of the pixel capacitor are controlled by turn-on and turn-off of the pixel transistor. When the display apparatus is powered off, according to the conventional voltage detection (commonly referred to as XAO) technique, when a detected power supply voltage drops below a predetermined value, pixel transistors of all the pixel units are turned on, thereby releasing voltages of the respective pixel capacitors. The conventional XAO technique is used to reduce the voltages of the pixel capacitors to zero volts by neutralization of voltages of different pixels and a line loss on a data line. A limited discharging rate is obtained using this method, and it is easy to observe a poor phenomenon such as an afterimage etc. of the display apparatus when the display apparatus is powered off.

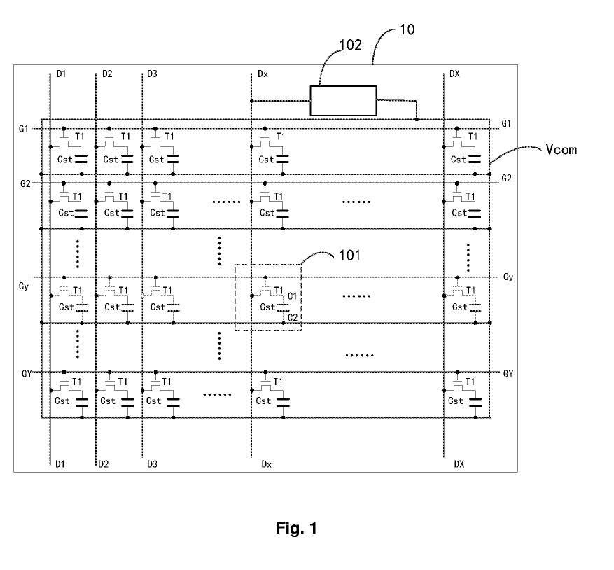

FIG. 1 illustrates a schematic block diagram of an array substrate according to an embodiment of the present disclosure. As shown in FIG. 1, the array substrate 10 according to the embodiment of the present disclosure may comprise a plurality of data lines D1-DX and a plurality of scanning lines G1-GY, wherein the plurality of data lines D1-DX intersect with the plurality of scanning lines G1-GY to form a matrix array. The array substrate 10 comprises a common electrode line VCOM and a plurality of pixel sub-circuits 101 disposed at intersections of the data lines Dx and the respective scanning lines Gy, wherein each of the pixel sub-circuits 101 comprises a pixel transistor T1 and a pixel capacitor Cst, the pixel capacitor Cst is connected between a corresponding one of the data lines Dx and the common electrode line Vcom via the pixel transistor T1, and a control terminal of the pixel transistor T1 is connected to a corresponding one of the scanning lines Gy. The array substrate 10 further comprises one or more control sub-circuits 102 connected between respective one or more data lines and the common electrode line and each configured to zero a voltage difference across a pixel capacitor in each of pixel sub-circuits connected to a corresponding one of the one or more data lines based on a control signal, wherein X and Y are integers greater than 1, x is an integer greater than or equal to 1 and less than or equal to X, and y is an integer greater than or equal to 1 and less than or equal to Y. The pixel transistor T1 of each of the pixel sub-circuits 101 has a control terminal connected to one of the scanning lines Gy for a row where the pixel sub-circuit is located, a first terminal connected to one of the data lines Dx for a column where the pixel sub-circuit is located, and a second terminal connected to a first terminal C1 of the pixel capacitor Cst, and a second terminal C2 of the pixel capacitor Cst is connected to the common electrode line Vcom.

It should be illustrated that “more” referred to in the present application refers to at least two.

It can be understood by those skilled in the art that although only one control sub-circuit 102 is shown in the example of FIG. 1, the array substrate according to the embodiment of the present disclosure may comprise more control sub-circuits connected between the respective data lines and the common electrode line respectively.

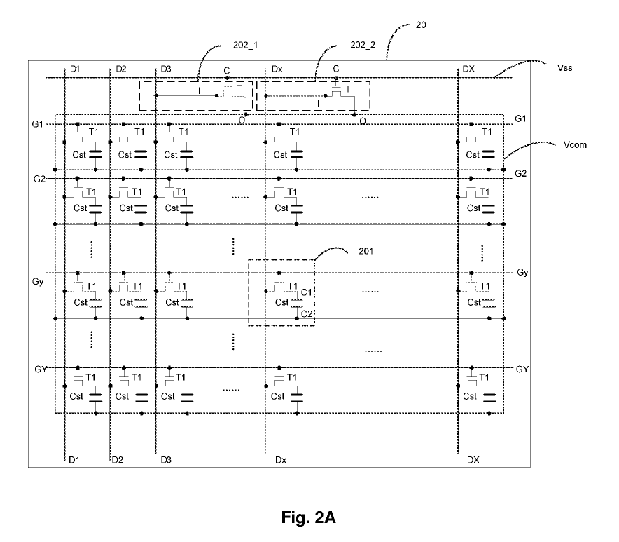

FIG. 2A illustrates a circuit diagram of an array substrate 20 according to an embodiment of the present disclosure. As shown in FIG. 2A, the array substrate 20 may comprise a common electrode line Vcom and a plurality of pixel sub-circuits 201 disposed at intersections of data lines Dx and respective scanning lines Gy. Similarly to the example of FIG. 1, each of the pixel sub-circuits 201 comprises a pixel transistor T1 and a pixel capacitor Cst. The pixel capacitor Cst is connected between a corresponding one of the data lines Dx and the common electrode line Vcom via the pixel transistor T1, and a control terminal of the pixel transistor T1 is connected to a corresponding one of the scanning lines Gy. The array substrate 20 further comprises one or more control sub-circuits. For example, two control sub-circuits 202_1 and 202_2 are shown in the example of FIG. 2A, and each of the control sub-circuits 202_1 and 202_2 may comprise at least one control transistor T. Each of the at least one control transistor T is used to control a column of pixel sub-circuits. For example, the control sub-circuit 202_1 controls a data column D3 in FIG. 2A, and the control sub-circuit 202_2 controls a data column Dx in FIG. 2A. The array substrate 20 further comprises a first power source line Vss, and each of the control transistors T has a control terminal C connected to the first power source line Vss, a first terminal I connected to the corresponding data line D3 or Dx, and a second terminal O connected to the common electrode line Vcom.

For the sake of brevity, only a case where one control transistor is disposed for one column of pixel sub-circuits is shown in FIG. 2A. According to an embodiment of the present disclosure, two or more control transistors may also be disposed for one column of pixels. This is particularly advantageous in a case where the display apparatus has a large area and a high resolution.

FIG. 2B illustrates a circuit diagram of an array substrate according to yet another embodiment of the present disclosure. As shown in FIG. 2B, each of the control sub-circuit 202_1 and the control sub-circuit 202_2 comprises two control transistors. That is, two control transistors are respectively disposed for, for example, the data columns D3 and Dx. The two control transistors are used to control the same column of pixel sub-circuits (for example, a column of pixel sub-circuits corresponding to D3 or Dx) and are respectively arranged at opposite ends of the same column of pixel sub-circuits. In addition, FIGS. 2A and 2B both only illustrates the case where the control transistors are disposed for the data columns D3 and Dx, and it can be understood by those skilled in the art that, one or more control transistors may of course be disposed for all odd data columns, all even data columns, or all data columns according to practical applications, and it only needs to connect a control terminal of each of the control transistors to the first power source line Vss, connect a first terminal of the control transistor to one of the data lines corresponding to a data column controlled by the control transistor, and connect a second terminal of the control transistor to the common electrode line Vcom.

In the examples of FIGS. 2A and 2B, similarly to the example of FIG. 1, the pixel transistor T1 of each of the pixel sub-circuits 101 has a control terminal connected to one of the scanning lines Gy for a row where the pixel sub-circuit is located, a first terminal connected to one of the data lines Dx for a column where the pixel sub-circuit is located, and a second terminal connected to a first terminal C1 of the pixel capacitor Cst, and a second terminal C2 of the pixel capacitor Cst is connected to the common electrode line Vcom.

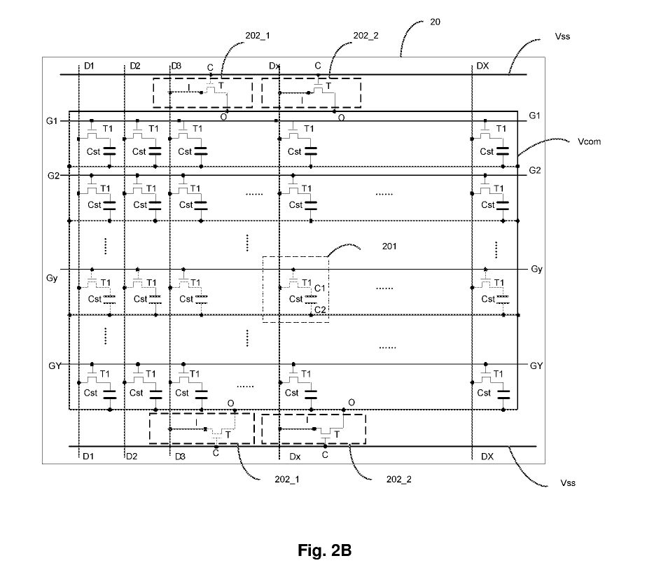

FIG. 3 illustrates a schematic block diagram of an array substrate according to another embodiment of the present disclosure. For the sake of brevity, the same or similar parts as those of FIGS. 1, 2A and 2B are omitted in FIG. 3, for example, the plurality of data lines D1-DX, the common electrode line Vcom, the pixel sub-circuits, and the control sub-circuit(s). As shown in FIG. 3, the array substrate 30 further comprises a first power source line Vss and a second power source line Vgh. The second power source line Vgh is connected to a plurality of scanning lines G1-GY to provide power to the plurality of scanning lines G1-GY. In addition, the array substrate 30 further comprises a control signal generation sub-circuit 303 configured to generate a control signal based on a trigger signal XAO, and output the control signal to the first power source line Vss, the second power source line Vgh, and the plurality of scanning lines G1-GY, to control voltages applied to the first power source line, the second power source line, and the scanning lines respectively.

It should be illustrated that the control signal generation sub-circuit according to the embodiment of the present disclosure may be implemented as a separate element, or its function may be integrated into a gate driving Integrated Circuit (IC) or other ICs.

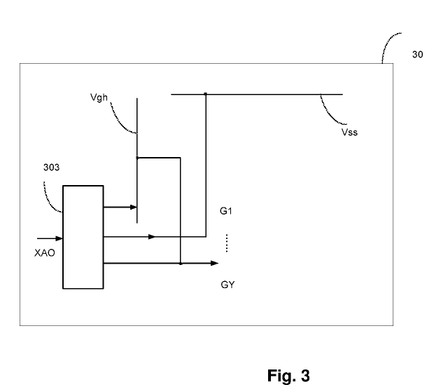

FIG. 4 illustrates an operation timing diagram of driving an array substrate according to an embodiment of the present disclosure. Next, the operation timing of driving the array substrate according to the embodiment of the present disclosure will be described in detail with reference to FIGS. 1, 2A, 2B, 3, and 4. For convenience of description, all the pixel transistors T1 and all the control transistors T in the following examples are N-channel Metal Oxide Semiconductor (NMOS) thin film transistors having a gate-on voltage at a high level. It can be understood by those skilled in the art that the pixel transistors T1 and the control transistors T may also be P-channel Metal Oxide Semiconductor (PMOS) thin film transistors, and it only needs to change a polarity of a gate control signal accordingly.

A first period T1 in FIG. 4 is a normal display period of the display apparatus. In the first period T1, a Vss voltage is a voltage for turning off each of the control transistors T, for example, −8V, and therefore, gates of all the control transistors in the control sub-circuits are turned off. At this time, the XAO signal is at, for example, 1.6V. All the pixel transistors T1 on the array substrate are turned on and turned off in sequence according to a data scanning direction under control of the scanning lines G1-GY. In one example, only one row of pixel transistors T1 is turned on by G1-GY at the same time, and other rows of pixel transistors T1 are all in a turn-off state. Then, data voltages on the respective data lines D1-DX are charged to the respective pixel capacitors Cst, so that the pixel sub-circuits have display brightness corresponding to the respective data voltages.

A second period T2 is a power-off period of the display apparatus. When the display apparatus is powered off, the XAO signal drops from 1.6V in the normal display period. When the control signal generation sub-circuit 303 detects that the XAO signal drops to, for example, 1.2V, an XAO function is triggered. The control signal generation sub-circuit 303 generates a control signal based on the trigger signal XAO, and outputs the control signal to all the scanning lines G1-GY, so that voltages on all the scanning lines G1-GY are at a high level Vgh which is usually 30V. Thereby, all the pixel transistors T1 are turned on, so that first terminals C1 of all the pixel capacitors Cst corresponding to the same data line (i.e., pixel capacitors of the same column of pixel sub-circuits) are connected to the corresponding data line, that is, the pixel capacitors Cst are discharged to the data line. At the same time, under control of the control signal, the Vss voltage on the first power source line for example changes from −8V to Vgh to follow Vgh, so as to turn on all the control transistors T, with a turn-on time t of usually 2ms-3ms. During this period, Vgh drops to Vgh1, which is about 15V, and Vss also rises to Vss1 of about 15V accordingly. Since the control transistors T are turned on, the respective data lines are connected to the common electrode line, to connect the respective data lines to the second terminals C2 of the respective pixel capacitors Cst, so that the voltages at the second terminals C2 of the pixel capacitors Cst are rapidly pulled down to be the same as the voltages of the respective data lines. Therefore, a voltage across each of the pixel capacitors Cst is equal to the voltage of the corresponding data line at this time, so that the voltage difference is zero, and thereby the display apparatus may rapidly display a black screen.

The plurality of control transistors may be located on the array substrate and have the same specification as that of the pixel thin film transistors. Therefore, the plurality of control transistors may be manufactured in the same process as the pixel transistors of the array substrate, thereby further reducing the cost.

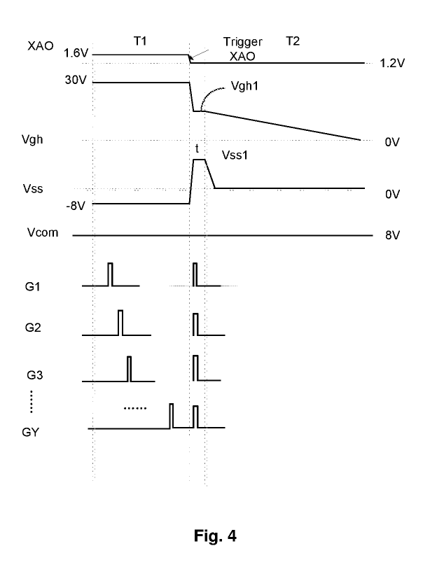

FIG. 5 illustrates a schematic block diagram of a display apparatus according to an embodiment of the present disclosure. As shown in FIG. 5, the display apparatus 50 may comprise the array substrate 510 according to the embodiment of the present disclosure. The display apparatus 50 according to the embodiment of the present disclosure may be any product or component having a display function such as an electronic paper, a mobile phone, a tablet, a television, a display, a notebook computer, a digital photo frame, a navigator, a display panel, etc.

According to an embodiment of the present disclosure, there is provided a method for driving an array substrate. It should be illustrated that serial numbers of the respective steps in the following method are only used as a representation of the steps for convenience of the description, and should not be regarded as indicating an execution order of the respective steps. This method does not need to be performed exactly as shown, unless explicitly stated.

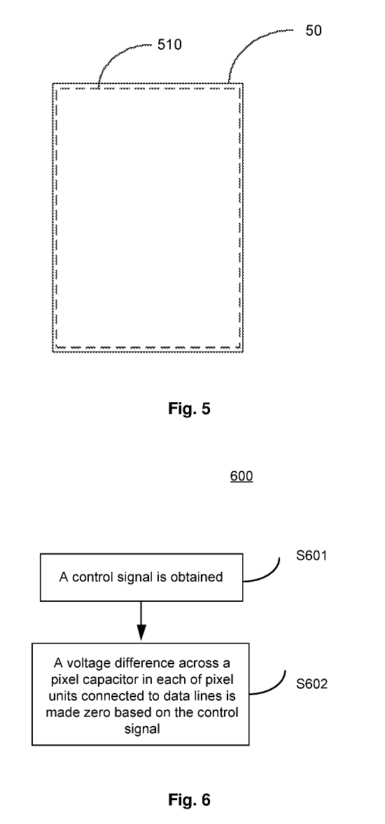

As shown in FIG. 6, a method 600 for driving the array substrate according to the embodiment of the present disclosure may comprise the following steps.

In step S601, a control signal is obtained.

In step S602, a voltage difference across a pixel capacitor in each of pixel sub-circuits connected to one or more data lines is made zero based on the control signal.

Step S601 may further comprise:

receiving a trigger signal; and

generating the control signal based on the received trigger signal.

The method 600 may further comprise: turning off the control transistor before the control signal is obtained, wherein the pixel transistor operates according to a voltage signal on a corresponding one of the scanning lines. That is, the display apparatus is in a normal display state.

When the received trigger signal is valid, for example, when the XAO signal is less than or equal to 1.2V since the display apparatus is powered off, in step S602, the control transistor and the pixel transistor are turned on, so that opposite ends of the pixel capacitor are connected to one of the data lines corresponding to a corresponding column. Specifically, the voltages on all the scanning lines G1-GY are at a high level Vgh which is usually 30V. Thereby, all the pixel transistors T1 are turned on, so that first terminals C1 of all the pixel capacitors Cst corresponding to the same data line are connected to the corresponding data line, that is, the pixel capacitors Cst are discharged to the data line. At the same time, under control of the control signal, Vss on the first power source line for example changes from −8V to Vgh to follow Vgh, so as to turn on all the control transistors T, with a turn-on time t of usually 2ms-3ms. At this time, Vgh drops to Vgh1, which is about 15V, and Vss also rises to Vss1 of about 15V accordingly. Since the control transistors T are turned on, the respective data lines are connected to the common electrode line, to connect the respective data lines to the second terminals C2 of the respective pixel capacitors Cst, so that the voltages at the second terminals C2 of the pixel capacitors Cst are rapidly pulled down to be the same as the voltages of the respective data lines. Therefore, a voltage across each of the pixel capacitors Cst is equal to the voltage of the corresponding data line at this time, so that the voltage difference is zero, and thereby the display apparatus may rapidly display a black screen.

According to an embodiment of the present disclosure, at least one control transistor is disposed respectively between at least one of the data lines and the common electrode line. When the display apparatus is powered off, the control transistor causes the voltage across the pixel capacitor to be the voltage of the corresponding data line at this time, so that the voltage difference is zero, and thereby the display apparatus may rapidly display a black screen. Thereby, the rapid discharging of the pixel capacitor is realized, and occurrence of a poor phenomenon such as white flashing on a screen etc. is avoided when the display apparatus is powered off.

The purposes, technical solutions and beneficial effects of the embodiments of the present disclosure have been further described in detail in the specific embodiments described above. It is to be understood that the foregoing description is only the specific embodiments of the present disclosure, instead of limiting the present disclosure. Any modifications, equivalent substitutions, improvements etc. which are made within the spirit and principle of the present disclosure should be included in the protection scope of the present disclosure.

1. An array substrate, comprising:
a plurality of data lines;
a plurality of scanning lines intersecting the plurality of data lines to form a matrix array;
a common electrode line;
a plurality of pixel sub-circuits disposed at intersections of the data lines and the scanning lines, wherein each of the pixel sub-circuits comprises a pixel transistor and a pixel capacitor, wherein the pixel capacitor is connected between a corresponding one of the data lines and the common electrode line via the pixel transistor, and a control terminal of the pixel transistor is connected to a corresponding one of the scanning lines; and
control sub-circuits, each connected between a respective data line and the common electrode line respectively and configured to electrically connect both electrodes of a pixel capacitor in each of pixel sub-circuits, which are connected to the respective data line, to the respective data line based on a control signal, so that a voltage difference between the electrodes of the pixel capacitor is made zero.

2. The array substrate according to claim 1, wherein each of the control sub-circuits comprises a control transistor configured to control a column of pixel sub-circuits.

3. The array substrate according to claim 2, wherein each of the control sub-circuits comprises two control transistors configured to control the same column of pixel sub-circuits and arranged on opposite ends of the same column of pixel sub-circuits respectively.

4. The array substrate according to claim 2, further comprising a first power source line, wherein a control terminal of the control transistor is connected to the first power source line, a first terminal of the control transistor is connected to one of the data lines corresponding to the column of pixel sub-circuits controlled by the control transistor, and a second terminal of the control transistor is connected to the common electrode line.

5. The array substrate according to claim 1, wherein a control terminal of the pixel transistor of each of the pixel sub-circuits is connected to one of the scanning lines for a row where the pixel sub-circuit is located, a first terminal of the pixel transistor is connected to one of the data lines for a column where the pixel sub-circuit is located, and a second terminal of the pixel transistor is connected to a first terminal of the pixel capacitor, and
a second terminal of the pixel capacitor is connected to the common electrode line.

6. The array substrate according to claim 1, further comprising:
a second power source line connected to the plurality of scanning lines to provide power to the plurality of scanning lines; and
a control signal generation sub-circuit configured to generate the control signal based on a trigger signal, and output the control signal to the first power source line, the second power source line, and the plurality of scanning lines to control voltages applied to the first power source line, the second power source line and the scanning lines respectively.

7. A display apparatus comprising the array substrate according to claim 1.

8. A method for driving the array substrate according to claim 1, comprising:
obtaining a control signal; and
zeroing a voltage difference across a pixel capacitor in each of pixel sub-circuits connected to the data lines based on the control signal.

9. The method according to claim 8, wherein the step of obtaining a control signal comprises:
receiving a trigger signal; and
generating the control signal based on the received trigger signal.

10. The method according to claim 8, wherein the control sub-circuit comprises at least one control transistor, each of which is configured to control a column of pixel sub-circuits; and a control terminal of the pixel transistor of each of the pixel sub-circuits is connected to one of the scanning lines for a row where the pixel sub-circuit is located, a first terminal of the pixel transistor is connected to one of the data lines for a column where the pixel sub-circuit is located, and a second terminal of the pixel transistor is connected to a first terminal of the pixel capacitor, and a second terminal of the pixel capacitor is connected to the common electrode line;
the method further comprises:
turning off the control transistor before the control signal is obtained, wherein the pixel transistor operates according to a voltage signal on a corresponding one of the scanning lines, and
the step of zeroing a voltage difference across a pixel capacitor in each of pixel sub-circuits connected to the data lines comprises: turning on the control transistor and the pixel transistor, so that opposite ends of the pixel capacitor are connected to one of the data lines corresponding to a corresponding column.

11. The method according to claim 9, wherein the array substrate further comprises: a first power source line connected to the plurality of data lines to provide power to the plurality of data lines; a second power source line connected to the plurality of scanning lines to provide power to the plurality of scanning lines; and a control signal generation sub-circuit configured to generate the control signal based on the trigger signal,
wherein the step of zeroing a voltage difference across a pixel capacitor in each of pixel sub-circuits connected to the data lines comprises: generating, by the control signal generation sub-circuit, the control signal based on the trigger signal, so that a voltage applied to the first power source line is equal to a voltage applied to the second power source line.

12. The array substrate according to claim 3, further comprising:
a second power source line connected to the plurality of scanning lines to provide power to the plurality of scanning lines; and
a control signal generation sub-circuit configured to generate the control signal based on a trigger signal, and output the control signal to the first power source line, the second power source line, and the plurality of scanning lines to control voltages applied to the first power source line, the second power source line and the scanning lines respectively.

13. A display apparatus comprising the array substrate according to claim 3.

14. A display apparatus comprising the array substrate according to claim 6.

15. A display apparatus comprising the array substrate according to claim 12.

16. The method according to claim 9, wherein the control sub-circuit comprises at least one control transistor, each of which is configured to control a column of pixel sub-circuits; and a control terminal of the pixel transistor of each of the pixel sub-circuits is connected to one of the scanning lines for a row where the pixel sub-circuit is located, a first terminal of the pixel transistor is connected to one of the data lines for a column where the pixel sub-circuit is located, and a second terminal of the pixel transistor is connected to a first terminal of the pixel capacitor, and a second terminal of the pixel capacitor is connected to the common electrode line;
the method further comprising:
turning off the control transistor before the control signal is obtained, wherein the pixel transistor operates according to a voltage signal on a corresponding one of the scanning lines, and
wherein the step of zeroing a voltage difference across a pixel capacitor in each of pixel sub-circuits connected to the data lines comprises: turning on the control transistor and the pixel transistor, so that opposite ends of the pixel capacitor are connected to one of the data lines corresponding to a corresponding column.
